(19) United States
(12) Patent Application Publication
(10) Pub. No.: US 2023/0173509 A1
(43) Pub. Date: Jun. 8, 2023

(54) SEPARATOR HAVING DIRECT DRIVE

(71) Applicant: GEA MECHANICAL EQUIPMENT GMBH, Oelde (DE)

(72) Inventors: Johannes DROSTE, Rosendahl (DE); Eduard BRAK, Oelde (DE); Tim HUNDERTMARK, Gütersloh (DE)

(73) Assignee: GEA MECHANICAL EQUIPMENT GMBH, Oelde (DE)

(21) Appl. No.: 17/920,433

(22) PCT Filed: Apr. 23, 2021
(86) PCT No.: PCT/EP2021/060665

§ 371 Date: Oct. 21, 2022

(30) Foreign Application Priority Data
Apr. 24, 2020 (DE) 10 2020 111 217.3

(51) Int. Cl. B04B 9/12; B04B 9/04; H02K 9/19; F16C 33/66; H02K 1/32; H02K 5/173; H02K 5/18; H02K 5/20; H02K 9/22

(52) U.S. Cl. CPC B04B 9/12; B04B 9/04; F16C 33/6659; H02K 1/32; H02K 5/18; H02K 5/203; H02K 5/1732; H02K 9/19; H02K 9/227

(57) ABSTRACT

A separator includes a unit that rotates during operation, the unit having a drum and a drive spindle, and an electric drive motor for rotating the drive spindle and having a stator and a rotor. The rotor is arranged on the drive spindle and the stator is radially spaced apart from the rotor in a drive housing that does not rotate during operation. The stator has at least one or multiple winding heads. At least one chamber is formed on at least one of the winding heads, and in this chamber a coolant film or coolant bath forms during operation so that this winding head is cooled by means of coolant during operation.

### BACKGROUND AND SUMMARY OF THE INVENTION

The invention relates to a separator having a rotatable drum, a drive spindle, and a drive motor having a rotor arranged on the drive spindle and a radially spaced apart stator that does not rotate during operation.

Such separators, which are also suitable for industrial use and can preferably be used in continuous operation, are known from the prior art, for example from DE 10 2017 113 649 A1.

Among the known systems, there are designs in which the drum, the drive spindle and the electric drive motor are rigidly connected to form a structural unit which is then elastically supported as a whole on a drive housing. Examples of such prior art are disclosed by GB 368 247, FR 1.287.551, DE 1 057 979 and DE 43 14 440 C1.

WO 2004/089550 discloses a separator in which the drum, the drive spindle, and the electric drive motor are also connected to form a structural unit, which can then be supported as a whole on a drive housing. A casing with an inner wall and an outer wall is placed around a housing or a machine frame. Between these walls, a space is formed in which a cooling fluid, e.g., water, can flow. In this way, the cooling fluid can cool the housing, which is substantially heated by the electric motor during operation of the centrifugal rotor. An element connected to the spindle is also provided to lubricate the bearings. This rotates with the spindle in the lubricating oil present in an oil chamber, so that some of the lubricating oil is converted into oil mist. The oil mist lubricates a lower bearing. The oil mist is further directed through channels to the inside of an upper bearing and to the suction side of a fan device. This results in lubrication of the upper bearing. The remaining oil mist is forced back down through a gap in the motor. This setup is complex and relatively complicated. In addition, the oil mist does not contribute to cooling the engine.

The cooling of the known drive devices still appears to be in need of improvement.

Exemplary embodiments of the invention are directed to improving the cooling of the drive device of the generic separator by simple means.

According to embodiments, a separator is provided comprising:
a unit which rotates during operation and which has a drum and a drive spindle,
a drive motor designed as an electric motor for rotating the drive spindle and having a stator and a rotor,
wherein the rotor is arranged on the drive spindle and the stator is radially spaced apart from the rotor in a drive housing which does not rotate during operation,
wherein the stator has at least one or multiple winding heads, and
wherein at least one chamber is formed on at least one of the winding heads, in which chamber a coolant film and/or bath is formed during operation, so that this winding head is cooled with coolant during operation or is cooled during operation.

According to this wording, one or more of the chambers may be formed on each of one or more winding heads.

In this way, one of the winding heads or, optionally, two winding heads are cooled in a simple manner, preferably directly in a coolant film or even bath that forms during operation on one or more outer surfaces. The coolant transports heat away from the winding heads.

Previously, the winding heads were surrounded by air. The thermal conductivity λ of air is 0.0262 W/mK. The thermal conductivity λ of lubricating oil can be, for example, 0.13 to 0.15 W/mK. Thus, the heat transfer to the surrounding medium is already considerably improved, e.g., by a factor of 5. In addition, the heat is dissipated more effectively by rotation or preferably circulation of the lubricating oil, whereas in the prior art the air surrounding the winding head was essentially stationary.

The coolant is a free-flowing coolant. Lubricating oil is used as the coolant, especially since this must be provided anyway for the lubrication of one or more bearings on the centrifuge. One advantage is that, due to the additional cooling of the winding heads, the motor can be loaded more heavily without the motor temperature rising above a permissible value. The cooling is more effective and the power density is therefore high.

It is therefore advantageous that the lubricating oil is used on the one hand for lubricating one or more bearings of the drive spindle and on the other hand for cooling the one or more winding heads.

The electric drive motor can be, for example, an asynchronous motor or a synchronous motor - e.g., a reluctance motor.

One advantage is that the existing lubricating oil, which is used to lubricate the rolling bearings, is now also used to cool the motor or the winding heads. Thus, the machine does not require any further aggregates and no further cooling medium such as water. The combination of direct heat dissipation from the motor stator - for example at cooling fins - and heat dissipation from the winding heads via lubricating oil flow to the cooling fins is thus particularly effective.

According to an advantageous but not mandatory design, the drive motor may preferably be located entirely between a neck bearing and a foot bearing.

According to an advantageous design, one winding head is an upper winding head and the other winding head is a lower winding head, and one or more chambers are formed on the upper winding head and/or on the lower winding head. If oil cooling chambers are formed on each of the two winding heads, both winding heads are cooled effectively and easily.

It is preferred that, for the purpose of effective cooling, the respective chamber on the respective winding head is formed as an annular chamber, which is formed at the top, outside, and/or bottom of the respective winding head, so that correspondingly an upper, an outer and/or a lower surface of the respective winding head is covered by a lubricating oil film during operation and is well cooled.

It is useful if the respective chamber has an inlet and an outlet, wherein the outlet can also be designed as an overflow.

It may be provided that one or both chambers may each be completely filled with the oil bath during operation. Inlet and outlet are then designed accordingly and coordinated with the oil inflow so that one or both chambers are filled. In this way, particularly good cooling and lubrication can be achieved or realized in the area of the respective chamber(s).

In order to be able to form the one or more chambers, it is advantageous if an integral or multi-piece motor housing is formed in the drive housing, which holds the stator. The chambers can then be formed between the motor housing and the stator, and these elements can be provided as a pre-assembled unit that can be mounted to the drive housing.

According to a particularly preferred design, it may be provided that the drive housing and/or the motor housing has cooling fins. The drive housing and/or the motor housing has one or more cooling channels through which lubricating oil that has been drained from one or both chambers flows. By means of the cooling fins, the thermal energy of the lubricating oil is then dissipated to the environment. In this way, all or part of the heat absorbed by the lubricating oil in the chambers is released back into the environment by convection.

It may be provided that the respective chamber at the respective winding head has an I-, L- or U-shaped cross-section.

Next, in an advantageous design, it may be provided that the respective chamber is formed between elements and/or sections of the motor housing and the respective winding head.

It may be provided that the pre-assembled drive and rotary system unit has a closed lubrication system circuit.

Advantageously, according to one variant, it can be provided that the drive spindle is axially penetrated by a bore, with the drive spindle being immersed in a lubricating oil sump at the bottom of the drive housing, with lubricating oil being conveyed through the bore of the drive spindle into the region of a neck bearing and/or into the region of a feed line of the chamber at the upper winding head.

According to a further structurally advantageous design, it may be provided that lubricating oil draining from the first chamber at the upper winding head is conducted through cooling channels in the drive housing and/or in the motor housing into the second chamber at the lower winding head, from where it is conducted back into the lubricating oil sump.

The invention also provides a method for cooling a drive motor of a separator, comprising the following steps: Providing a separator - in particular according to one of the embodiments described above as being according to the invention - and filling and flowing lubricating oil through the one or more chambers during operation.

In order to provide a structurally compact and easily manageable separator, it is further advantageous if (preferably exclusively) air cooling is provided as the cooling system, which comprises cooling fins on the outer circumference of the drive housing.

Finally, it can be advantageously - but not necessarily - provided that the rotating system with the drum and the drive spindle is supported essentially axially via the foot bearing in the drive housing. However, other variants with support at the neck bearing can also be implemented in this respect.

### BRIEF DESCRIPTION OF THE DRAWING FIGURES

The invention is described in more detail below by means of exemplary embodiments with reference to the drawings, wherein:

FIG. 1 shows a sectional view of a separator according to the invention shown in schematic form;

FIG. 2 shows a perspective view of a further separator according to the invention;

FIG. 3a, b show in a) a first upper detail enlargement from FIG. 1 and in b) a second lower detail enlargement from FIG. 1, in which a flow path for a coolant is shown with arrows and hatching in each case.

### DETAILED DESCRIPTION

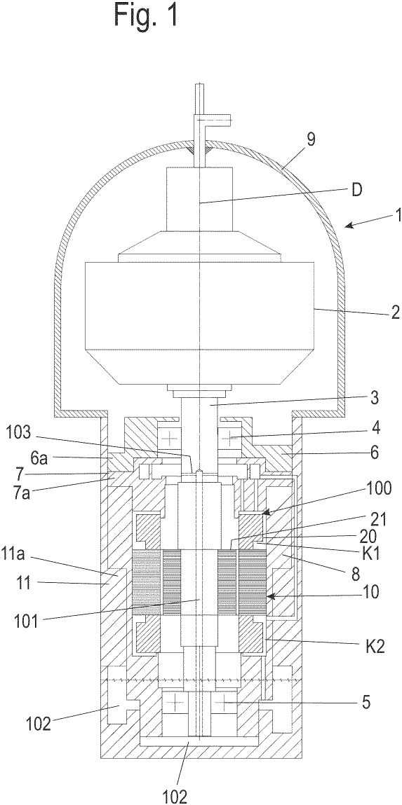

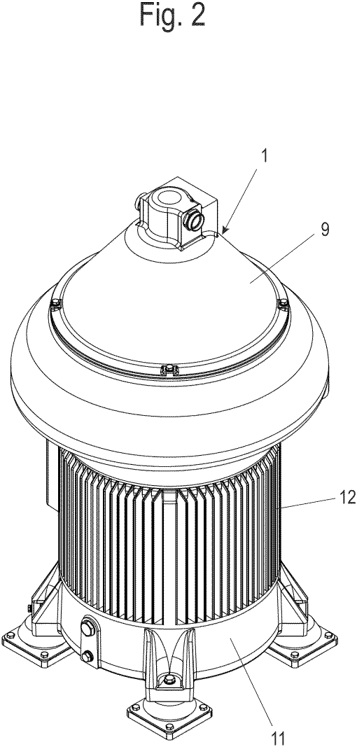

FIG. 1 shows a separator 1 having a system that does not rotate or is stationary during operation and a system that rotates or is rotating relative to the stationary system during operation. In this case, the rotating system and the stationary system each have a plurality of elements.

The rotating system of the separator comprises a drum 2 with a vertical axis of rotation D. This drum 2 is shown here only schematically. It can be designed in various ways. Preferably, it is designed for continuous operation for continuous clarification and/or separation of a flowable product into one or two liquid phases and optionally a solid phase - in particular in an industrial process. For this purpose, its interior space is preferably provided with a separating disc stack of separating discs (not to be seen or shown here). The, preferably single or double, conical drum 2 is placed on the here vertical upper end of a rotatable drive spindle 3. The drive spindle can be aligned vertically or, in operation, essentially vertically and have a vertical axis of rotation D.

The drum 2 can have an inlet and at least two outlets for the phases of the product or mixture of substances to be processed, which are separated in the centrifugal field.

The drive spindle 3 is rotatably supported by a bearing arrangement, which here comprises a neck bearing 4 and a foot bearing 5. The neck bearing 4 is arranged in a bearing housing 6 - preferably radially elastically supported. An elastic element such as an elastic ring can be arranged in this case between the inner circumference of the bearing housing 6 and the outer circumference of the neck bearing 4 (not shown here). The bearing housing 6 does not rotate and is therefore part of the system that is stationary during operation.

The bearing housing 6 can be mounted on an integral or multi-part motor housing 7, 8. The motor housing can consist of several sections. In particular, it can have a motor housing cover ring 7 which is placed on the lower motor housing 8.

The bearing housing 6, optionally the motor housing cover ring 7 and the motor housing 8 can each have an annular flange section 6a, 7a and 8a respectively on their outer circumference. These annular flange sections 6a, 7a, 8a can each lie axially stacked one above the other. They can be joined or are joined together - e.g., with axial screws not shown here - to form a module-like unit. Together they can form a ring flange section of a pre-assemblable and here also pre-assembled drive and rotary system unit.

A drive motor 10, which is an electric motor, is arranged in the integral or multi-part motor housing 8. Optionally, the foot bearing 5 can also be formed or arranged there. The drive motor 10 has a stator 20 and a rotor 21. The stator 20 is fixed here directly or indirectly in or on the drive housing 11. It does not rotate during operation. The rotor 21, on the other hand, can be connected to the drive spindle 3 in a rotationally fixed manner.

The system with the bearing housing 6, optionally the motor housing cover ring 7 and the integral or multi-piece motor housing 8, can form a pre-assembled drive and rotary system unit in the manner of a replaceable cassette that can be mounted as a whole. This pre-assembled drive and rotary system unit is also referred to hereinafter as the pre-assembled unit for short. This pre-assembled unit may also comprise the drum 2. This structure is advantageous in this respect, but not necessarily to be implemented exactly in this way in order to realize the invention.

The motor housing 8 is inserted into a drive housing 11 and held there. This drive housing 11 can be designed in the form of an outer housing surrounding the motor housing 8. However, it can also be designed as a frame. The drive housing 11 can, for example, be fastened to a base such as a hall floor or the like.

Cooling fins 12 can be formed on the outer circumference of the drive housing 11 in order to easily dissipate or radiate waste heat from the drive system into the ambient space.

The drive housing 11 has a ring flange 11a on its inner circumference. The pre-assembled drive and rotary system unit can be attached to this ring flange 11a. Here, the outer ring flange section of the pre-assembled drive and rotary system unit can rest on the inner ring flange 11a of the drive housing 11 as shown, or in an alternative design hang below it.

The pre-assembled unit and its annular flange section are preferably fastened, in particular screwed tight, to the annular flange 11a of the drive housing 11 by at least one or more fastening means, in particular one or more screw bolts (not shown here).

Furthermore, a hood 9 can be attached to the drive housing 11, which does not rotate during operation and encloses the drum 2.

On the one hand, an air cooling system can be used to cool the drive with the drive motor 10, implemented by the cooling fins 12. This is advantageous and simple.

It is also proposed to use liquid cooling as a supplement or alternative. A corresponding liquid cooling system is designated below by the reference sign 100.

In this liquid cooling system 100, a lubricant circulation system is advantageously used for liquid cooling of the motor 10. It is particularly advantageous to use or at least also use a lubricant circulation system for this purpose, which also serves to lubricate at least one of the bearings 4, 5 with lubricant.

According to a possible design according to the invention, the lubricant circulation system may be constructed as follows:

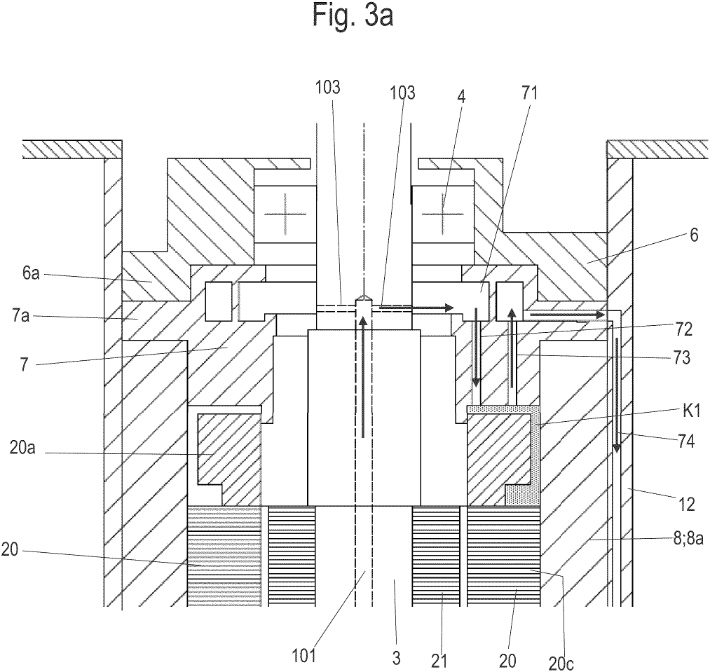

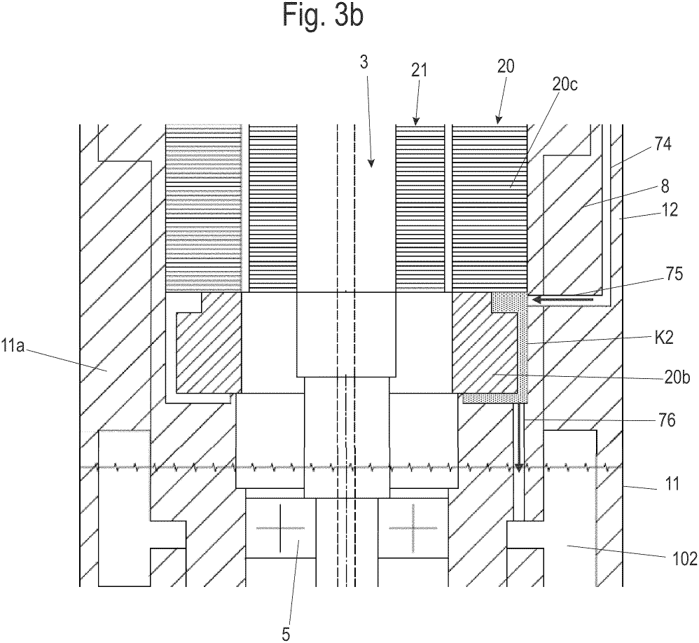

A lubricant supply line is used to supply the bearings 4, 5 with lubricant. This lubricant supply line can be implemented in various ways. For example, the drive spindle 3 can have a bore 101 passing through it axially, with the drive spindle 3 being immersed in a lubricating oil sump 102 at the bottom of the drive housing 11 (the upper lubricant level of which is indicated by a dashed line). Lubricating oil is conveyed through the bore 101 of the drive spindle 3 in the manner of a suction pipe into the area below the neck bearing 4. The bore 101 in the drive spindle 3 thus serves here as the lubricant supply line. From the bore 101, the lubricating oil can be guided radially further radially outward in the rotating system through one or more radially extending transverse bores 103 until it emerges from the transverse bore 103 of the drive spindle 3 into a stationary annular space outside the drive spindle 3 (see also FIG. 3a).

The lubricating oil emerging from the drive spindle 3 meets stationary components located radially outside the drive spindle 3, in this case the motor housing cover ring 7 and/or the motor housing 8. The neck bearing 4 can be lubricated by a lubricating oil mist produced during operation.

A portion of the lubricating oil may further return downwardly into the lubricating oil sump 102 in a chamber extending concentrically with the drive spindle 3. The foot bearing 5 may be located in the lubricating oil sump and lubricated thereby. However, it may also be located above the lubricating oil sump and be lubricated as the lubricating oil returns to the lubricating oil sump.

According to the invention, in particular the cooling of the stator 20 fixed in the drive housing is optimized. The stator 20 has upper and lower winding heads 20a and 20b and a coil pack 20c. It is constructed as a kind of ring element, with the coil pack being located centrally between the upper and lower winding heads 20a, 20b.

At least one chamber K1, K2 is formed on the stator 20, in particular on the upper and/or on the lower winding head 20a, 20b, which fills with lubricating oil during operation so that at least part of the outer surface of the respective winding head 20a and/or 20b lies in a lubricating oil bath or is covered by a lubricating oil film during operation. The respective chamber K1 is configured to have an inlet and an outlet. The inlet and the outlet are designed such that the respective chamber K1 and/or K2 is preferably completely filled with lubricating oil during operation.

Advantageously, one of the chambers K1, K2 can be formed on both the upper winding head 20a and the lower winding head 20b.

The chambers K1 and/or K2 are preferably designed as annular chambers which extend radially on the outside and, optionally, at the top and/or bottom of and around the respective winding head 20a and/or 20b.

It may be provided that at least one drainage channel (which may branch into several cooling channels) from at least one of the chambers K1, K2 is guided through the drive housing and/or the motor housing in the area of the cooling fins 12 in order to be able to radiate the heat absorbed by the lubricating oil from the respective chamber K1 and/or K2 from there via the cooling fins to the surroundings.

In this way, air cooling is used to particular advantage or combined with liquid cooling. In the exemplary embodiment shown, this is advantageously - but not necessarily - implemented as follows.

The motor housing cover ring 7 is located above the stator 20. The motor housing 8 (which is also preferably annular) is again arranged radially outside the stator 20. This can extend - in one or more parts - downward to the lubricating oil sump 102.

The motor housing cover ring 7 has an annular chamber 71 that is open towards the inside. This annular chamber 71 collects part of the lubricating oil emerging radially from the drive spindle 3. The motor housing cover ring 7 can also have an inlet channel 72 with which lubricating oil is fed from the annular chamber 71 into the chamber K1, which is formed radially on the outside as an annular chamber between the winding head 20a and adjacent elements of the motor housing. Here, these are the elements motor housing cover ring 7 and motor housing 8.

The chamber K1 fills with lubricating oil during operation. The chamber K1 can be designed as an annular chamber. The chamber K1 can further have an I-shaped, L-shaped, or preferably U-shaped cross-section. It is preferred if the chamber K1 is designed in such a way (in particular with regard to the volume of the chamber K1 and with regard to the quantity of oil flowing through it) that the lubricating oil does not heat up by more or less than 20° K when flowing through the chamber K1 during operation. In this way, excessive heating in the areas around chamber K1 can be avoided very well.

FIG. 3a illustrates how, in operation, chamber K1 is filled with lubricating oil passing through channel 72. This lubricating oil cools the upper winding head 20a on one, two, or here even three of its sides. In particular, these are the top side, the bottom side, and the radially outer side of the upper winding head 20a.

An outlet channel 73 can emerge from the chamber K1. This leads here (optionally first upwards and then) radially outwards into (or merges into) a cooling channel 74, which is guided through the drive housing and/or the motor housing, provided with one or more of the cooling fins 12, so that some or all of the heat absorbed by the lubricating oil in the chamber K1 at the upper winding head 20a can be re-radiated via one or more cooling fins 12.

The cooling channel 74 in turn merges into an inlet channel 75 (here leading radially inwards), which opens into the second chamber K2 on the lower winding head 20b.

Also, the lower winding head 20b is surrounded by lubricating oil in this chamber K2 radially outside and/or above and/or below on one, two or three sides of a chamber K2. The chamber K2 may also be configured as an annular chamber. Also, the chamber K2 can have an I-shaped, L-shaped, or U-shaped cross-section.

FIG. 3b illustrates how, in operation, chamber K2 is filled with lubricating oil by lubricating oil passing through channel 75. This lubricating oil cools the lower winding head 20b on one, two, or here even three of its sides. In particular, these are the upper side, the lower side, and the radially outer side of the lower winding head 20b.

The chamber K2 between the lower winding head 20b and the motor housing 8 also fills with lubricating oil due to the fact that lubricating oil continues to be fed from the sump into the chamber K1 and provides cooling for the lower winding head 20b.

In this case, the lubricating oil can drain from the lower chamber K2 downward through another outlet channel 76 toward the lubricating oil sump 102, into which it eventually flows.

The design of chamber K2 - in particular the volume and flow rate of the lubricating oil during operation - should preferably be selected so that the lubricating oil does not heat up by more than or preferably less than 20° K when flowing through chamber K2. This is because with such a design, overheating in the area around this chamber K2 can be prevented particularly reliably.

In this way, it is provided that the lubricating oil flows past the stator 20 and in particular past one or both winding heads 20a, 20b in an additionally targeted manner in such a way that the lubricating oil actively cools one or preferably both of the winding heads 20a, 20b by a specific lubricant flow and film. In addition, the winding heads are cooled in such a way that there is preferably a kind of lubricating oil bath in the chambers K1, K2, the lubricating oil of which is, however, repeatedly replaced by lubricating oil flowing in.

The two winding heads 20a, 20b can have an approximately rectangular basic shape in cross-section. In this case, an inner side of the stator 20 can be spaced from the drive spindle 3 and the rotor 21 by an annular space. In this area, preferably no supplementary lubricant flow is realized, at least none that goes beyond the cooling effect exerted in this annular space by the lubricating oil flowing from the neck bearing to the foot bearing.

At the outer circumference, on the other hand, the upper and/or the lower winding head are enclosed by the drive housing or components on the drive housing in such a way that they form one or more chambers K1, K2, in particular annular chambers, on one, two or preferably even three of its sides.

Here, the motor housing cover ring 7 arranged above the stator is designed in such a way that it conducts lubricating oil through the channel 72 into the first chamber K1, which surrounds the upper winding head on three sides here. This chamber K1 fills with lubricating oil during operation. As soon as it overflows, the overflowing lubricating oil flows through a further channel 74 in the direction of the further chamber K2, which surrounds the lower winding head 20b on one, two or three sides.

From this lower chamber K2, the outlet channel 76 finally leads back into the lubricating oil sump like a bore or channel.

In this way, the lubricating oil even passes directly by both winding heads 20a, 20b to cool them and is finally conveyed back to the lubricating oil sump 102.

It is thus provided that one or more channels and/or chambers K1, K2 are formed between the stator 20 and one or more adjacent components of the drive housing 11, which here include the motor housing cover ring 7 and the motor housing 8, which channels and/or chambers K1, K2 are completely or partially filled with lubricating oil during operation, wherein a flow of lubricating oil is also produced in order to actively cool the stator, in particular its one or both winding heads 20a, 20b, as directly as possible with lubricating oil by directly flowing over at least one surface region of the winding heads 20a, 20b.

The invention can be implemented in various ways. This has been advantageously done in FIGS. 1, 3a and 3b. However, it is of course also possible to implement the invention in a different constructive manner in other constructive designs.

The lubricating oil flows into the annular chambers K1 and K2, or at least part of the lubricating oil flows out of the drive spindle 3 below the neck bearing.

Preferably, the lubricating oil is directed selectively over one or both of the winding heads 20a, 20b, and it may further preferably be provided that one or both of the winding heads 20a, 20b are partially immersed in a lubricating oil bath during operation. The overflow can be designed such that the lubricating oil level in the upper chamber K1 always completely surrounds the upper winding head 20a. The submergence helps to dissipate heat generated by ohmic losses in the upper winding head 20a. The overflowing lubricating oil can then, or while flowing through, be directed through one or more cooling channels 74 in the drive housing and/or the motor housing, thus easily dissipating heat to the environment via the cooling fins 12 of the drive housing 11.

The cooled lubricating oil then flows into a similar chamber K2, which surrounds the lower winding head 20b. The outlet from this can again be designed so that the lubricating oil level in the container always completely surrounds the winding head. This can be achieved, for example, by a suitable orifice in the outlet of the container or by a suitable cross-section of the outlet channel 76.

In this way, the two winding heads 20a, 20b of the integrated motor are actively cooled by the returning lubricating oil. On the one hand, part of the heat dissipated by the winding heads is absorbed and conducted away by the flowing lubricating oil, and on the other hand, part of the heat dissipated by the winding heads is conducted to the surrounding separator housing by the lubricating oil standing in the chambers around the winding heads. For this purpose, the chambers around the winding head should be filled with lubricating oil.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

List of reference signs

| | |
|---|---|
| 1 | Separator |
| 2 | Drum |
| 3 | Drive spindle |
| 4 | Neck bearing |
| 5 | Foot bearing |
| 6 | Bearing housing |
| 6 a | Annular flange section |
| 7 | Motor housing cover ring |
| 7 a | Annular flange section |
| 71 | Annular chamber |
| 72 | Inlet channel |
| 73 | Outlet channel |
| 74 | Cooling channel |
| 75 | Inlet channel |
| 76 | Outlet channel |
| 8 | Motor housing |
| 8 a | Ring flange section |
| 9 | Hood |
| 10 | Drive motor |
| 11 | Drive housing |
| 11 a | Ring flange |
| 12 | Cooling fin |
| 20 | Stator |
| 20 a | Winding head |
| 20 b | Winding head |
| 20 c | Coil pack |
| 21 | Rotor |
| 100 | Liquid cooling system |
| 101 | Bore |
| 102 | Oil sump |
| 103 | Transverse bores |
| K1, K2 | Chambers |
| D | Axis of rotation |

1-18. (canceled)

19. A separator, comprising:
a unit that rotates during operation of the separator, wherein the unit that rotates includes a drum and a drive spindle;
a drive motor configured to rotate the drive spindle, wherein the drive motor is an electric motor having a stator and a rotor,
wherein the rotor is arranged on the drive spindle and the stator is radially spaced apart from the rotor in a drive housing, wherein the drive housing does not rotate during operation of the separator, and wherein the stator has at first and second winding heads;
first chamber formed on the first winding head and a second chamber formed on the second winding head, wherein the first and second chambers are configured so that a coolant film or a coolant bath is formed during operation of the separator to cool the first and second winding heads during operation of the separator,
wherein coolant for the coolant film or the coolant bath is a lubricating oil that lubricates one or more bearings of the drive spindle and cools the first and second winding heads,
wherein the first winding head is an upper winding head and the second winding head is a lower winding head, and
wherein one or both of the first and second chambers is/are completely filled with the oil bath during operation of the separator.

20. The separator of claim 19, wherein the first and second chambers annular chambers formed at a top, outside or bottom of the first and second winding heads, respectively, so that correspondingly an upper, an outer or a lower surface of the respective winding head is partially or completely covered by the lubricating oil film during operation.

21. The separator of claim 19, wherein the first and second chambers each have an inlet and an outlet.

22. The separator of claim 19, wherein one or more cooling channels are formed in the drive housing.

23. The separator of claim 22, wherein the drive housing has cooling fins and the one or more of the cooling channels have lubricating oil flowing through them, which has been discharged from one or both of the first and second chambers to dissipate thermal energy of the lubricating oil to an environment via the cooling fins.

24. The separator of claim 19, wherein the first and second chambers are configured such that the lubricating oil does not heat up by more or less than 20°K when flowing through the first and second chambers during operation of the separator.

25. The separator of claim 19, wherein the first chamber is formed between elements or sections of the motor housing and the first winding head and the second chamber is formed between elements or sections of the motor housing and the second winding head.

26. The separator of claim 23, wherein the drive spindle is axially penetrated by a bore, wherein the drive spindle is immersed in a lubricating oil sump at a bottom of the drive housing, wherein lubricating oil is conveyed through the bore of the drive spindle into a region of a neck bearing or into a region of a feed line of the first chamber.

27. The separator of claim 26, wherein lubricating oil draining from the first chamber at the upper winding head is directed through the one or more cooling channels into the second chamber at the lower winding head, and then the lubricating oil is directed back into the lubricating oil sump.

28. The separator of claim 19, wherein the drum is a single or double, conical drum placed on an upper end of a rotatable drive spindle.

29. The separator of claim 19, wherein a separating disc stack of separating discs is arranged in the drum.

30. The separator of claim 19, wherein the bore of the drive spindle, the one or more cooling channels, the first and second chambers, the drum, and motor housing form the pre-assembled drive and rotary system unit comprising a closed lubrication system circuit.

31. The separator of claim 19, wherein the drive motor is located between a neck bearing and a foot bearing.

32. A method for cooling a drive motor of a separator, the method comprising:
A) providing the separator, which comprises
a unit that rotates during operation of the separator, wherein the unit that rotates includes a drum and a drive spindle;
a drive motor configured to rotate the drive spindle, wherein the drive motor is an electric motor having a stator and a rotor,
wherein the rotor is arranged on the drive spindle and the stator is radially spaced apart from the rotor in a drive housing, wherein the drive housing does not rotate during operation of the separator, and wherein the stator has at first and second winding heads;
first chamber formed on the first winding head and a second chamber formed on the second winding head, wherein the first and second chambers are configured so that a coolant film or a coolant bath is formed during operation of the separator to cool the first and second winding heads during operation of the separator,
wherein coolant for the coolant film or the coolant bath is a lubricating oil that lubricates one or more bearings of the drive spindle and cools the first and second winding heads, and
wherein the first winding head is an upper winding head and the second winding head is a lower winding head; and
B) flowing the lubricating oil through the first and second chambers during operation of the separator in such a way that the first and second chambers are completely filled with an oil bath during the operation of the separator.

33. The method of claim 32, wherein the lubricating oil flows through the first and second chambers in such a way that the lubricating oil heats up by less than 20°K when flowing through the first chamber and second chamber, respectively.
